(19) United States
(12) Patent Application Publication
(10) Pub. No.: US 2011/0095869 A1
(43) Pub. Date: Apr. 28, 2011

(54) METHOD AND APPARATUS FOR REAL TIME LOCATION TRACKING USING RFID

(75) Inventors: Hoe-Sung Yang, Daejeon (KR); Seung Il Myong, Daejeon (KR); Jae Heum Lee, Daejeon (KR); Heyung Sub Lee, Daejeon (KR); Jong-Suk Chae, Daejeon (KR)

(73) Assignee: Electronics and Telecommunications Research Institute, Daejeon (KR)

(21) Appl. No.: 12/994,644

(22) PCT Filed: Dec. 31, 2008
(86) PCT No.: PCT/KR2008/007831

§ 371 Date: Nov. 24, 2010

(30) Foreign Application Priority Data
Jun. 9, 2008 (KR) 10-2008-0053745
Sep. 2, 2008 (KR) 10-2008-0086298

(51) Int. Cl. H04Q 5/22

(52) U.S. Cl. 340/10.1

(57) ABSTRACT

Proposed are a method and apparatus for real-time location tracking using Radio Frequency Identification (RFID), the apparatus including: a first reception information receiver to receive first reception information of a tag signal from a plurality of RFID readers that receives the tag signal from an RFID tag; a reader group generator to select, from the plurality of RFID readers, at least three RFID readers based on the first reception information and generate an RFID reader group including the selected at least three RFID readers; and a location calculator to calculate a location of the RFID tag based on first reception information that is received from the at least three RFID readers included in the RFID reader group.

### TECHNICAL FIELD

The present invention relates to an apparatus and method for real-time location tracking using Radio Frequency Identification (RFID), and more particularly, to an apparatus and method for real-time location tracking using RFID that can measure a location of an object with an attached RFID tag in real time.

This work was supported by the IT R&D program of MIC/IITA. [2008-S-040-01, Development of real-time locating systems].

### BACKGROUND ART

Radio Frequency Identification (RFID) denotes a technology that integrates usage of electromagnetic or electrostatic coupling in a radio frequency of an electromagnetic spectrum portion in order to identify an object, an animal, a human being, and the like. The RFID is being widely used in the industry as a replacement technology of a barcode. The RFID does not require direct contact or scanning in a visible band.

An RFID system generally includes an antenna, a reader, and a tag. The antenna can be used in order to transmit radio frequency (RF) signals. When the tag is activated, the tag can transmit stored data to the reader via a transmit antenna. A receive antenna is connected to the reader and thus the reader can receive the data from the tag via the receive antenna. Through this, data may be transmitted using the RFID.

A conventional location tracking using the RFID is generally performed based on a

Global Positioning System (GPS) or base station location information of a mobile communication network. Also, the location tracking is generally performed based on bi-directional communication between the reader and the tag, or between the reader and another reader.

The GPS may provide a stable service with a wide signal radius via a satellite, whereas a service target region is limited to outdoors. Also, the satellite includes an error due to a security matter. Thus, the GPS has a deteriorated precision. Also, a GPS module generally consumes a large amount of power and spends a relatively longer period of time to find an initial location due to a cold start. The error range of the location tracking technology using a base station of a mobile communication network reaches hundreds of meters to a number of kilometers.

A conventional RFID location tracking system includes a tag that is attached to an object, a plurality of readers that is fixed to a particular region, and a computer that calculates a location of the object based on a signal transmitted from each of the readers/tag. The signal includes time information. A location measurement scheme may be classified into a uni-directional measurement scheme and a bi-directional measurement scheme.

In comparison to the bi-directional measurement scheme, the uni-directional measurement scheme consumes a relatively small amount of power since it has a relatively simple configuration and uni-directionally transmits the signal. However, in order to accurately measure the location of the tag, the uni-directional measurement scheme may need to overcome a synchronization problem between the plurality of readers. In the bi-directional measurement scheme, a system is complex and the tag and the reader consumes a large amount of power.

### DISCLOSURE OF INVENTION

### Technical Problem

An aspect of the present invention provides an apparatus and method for real-time location tracking using Radio Frequency Identification (RFID) that can reduce an unnecessary calculating process and a power consumption.

Another aspect of the present invention also provides an apparatus and method for real-time location tracking using RFID that can perform synchronization between a plurality of RFID readers without using a separate device.

### Technical Solution

According to an aspect of the present invention, there is provided an apparatus for real-time location tracking using Radio Frequency Identification (RFID), the apparatus including: a first reception information receiver to receive first reception information of a tag signal from a plurality of RFID readers that receives the tag signal from an RFID tag; a reader group generator to select, from the plurality of RFID readers, at least three RFID readers based on the first reception information and generate an RFID reader group including the selected at least three RFID readers; and a location calculator to calculate a location of the RFID tag based on first reception information that is received from the at least three RFID readers included in the RFID reader group.

According to another aspect of the present invention, there is provided a method for real-time location tracking using RFID, the method including: receiving, from a plurality of RFID readers, first reception information of a tag signal that is received from an RFID tag; selecting, from the plurality of RFID readers, at least three RFID readers based on the first reception information to generate an RFID reader group including the selected at least three RFID readers; and calculating a location of the RFID tag based on first reception information that is received from the at least three RFID readers included in the RFID reader group.

### BRIEF DESCRIPTION OF THE DRAWINGS

FIG. 1 is a block diagram illustrating a configuration of an apparatus for real-time location tracking using Radio Frequency Identification (RFID) according to an embodiment of the present invention;

FIGS. 2 through 4 illustrate a location tracking operation using RFID according to an embodiment of the present invention; and

FIGS. 5 and 6 are flowcharts illustrating a method for real-time location tracking using RFID according to an embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

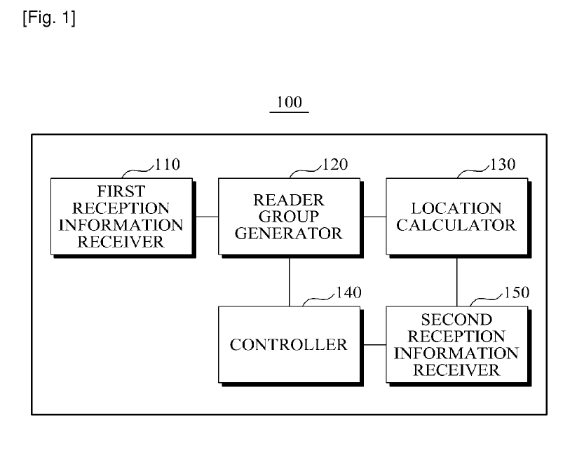

FIG. 1 is a block diagram illustrating a configuration of an apparatus 100 for real-time location tracking using Radio Frequency Identification (RFID) according to an embodiment of the present invention.

The real-time location tracking apparatus 100 using the RGID includes a first reception information receiver 110, a reader group generator 120, and a location calculator 130. According to an aspect of the present invention, the real-time location tracking apparatus 100 may further include a controller 140 and a second reception information receiver 150. Hereinafter, a function of each constituent element will be described in detail.

The first reception information receiver 110 may receive first reception information of a tag signal from a plurality of RFID readers that receives the tag signal from an RFID tag. The reader group generator 120 may select, from the plurality of RFID readers, at least three RFID readers based on the first reception information and generate an RFID reader group including the selected at least three RFID readers.

The RFID tag may transmit the tag signal to the plurality of RFID readers for location tracking of an object with the attached RFID tag. The RFID tag may periodically transmit the tag signal to the RFID readers.

The plurality of RFID readers receiving the tag signal may generate the first reception information associated with the received tag signal and transmit the first reception information to the real-time location tracking apparatus 100. The first reception information receiver 110 may receive the first reception information. The reader group generator 120 may select, from the plurality of RFID readers, at least three RFID readers based on the first reception information and generate an RFID reader group including the selected at least three RFID readers. The RFID reader group denotes a set of RFID readers that are used to track a location of the RFID tag.

According to an aspect of the present invention, the location calculator 130 may track a location of an RFID tag using a triangulation scheme and thus the reader group generator 120 may generate an RFID reader group that includes at least three RFID readers from a plurality of RFID readers transmitting first reception information.

According to an aspect of the present invention, the first reception information may include a first reception time value regarding a point in time when each of the RFID readers receives the tag signal. The reader group generator 120 may generate the RFID reader group according to a smaller order of the first reception time value.

The first reception time value denotes a time value at a point in time when a corresponding RFID reader receives the tag signal. As the first reception time value becomes smaller, the RFID reader may be positioned in a closer location from the RFID tag that transmitted the tag signal. As the location from the RFID tag becomes closer, the location may be more accurately measured. Therefore, the reader group generator 120 may group the at least three RFID readers into the RFID reader group according to the smaller order of the first reception time value.

According to an aspect of the present invention, the first reception information may include a first energy value of the received tag signal, and the reader group generator 120 may generator the RFID reader group according to a larger order of the first energy value.

The first energy value denotes an energy value of the tag signal at a point in time when the corresponding RFID reader receives the tag signal. The first energy value may include at least one of an intensity of received tag signal and an energy value estimated according to an energy estimation algorithm As the first energy value becomes larger, the RFID reader may be positioned in a closer location from the RFID tag. As the location from the RFID tag becomes closer, the location may be more accurately measured. Therefore, the leader group generator 120 may group the at least three RFID readers into the RFID reader group according to the larger order of the first energy value.

The location calculator 130 may calculate the location of the RFID tag based on the first reception information that is received from the at least three RFID readers included in the RFID reader group.

As described above, the first reception information may include at least one of the first energy value of the received tag signal and the first reception time value regarding the point in time when each of at least three RFID readers of the RFID reader group receive the tag signal from the RFID tag. According to an aspect of the present invention, the location calculator 130 may calculate the location of the tag using a Time of Arrival (TOA) algorithm based on the time value when a corresponding RFID reader receives the tag signal. Also, the location calculator 130 may calculate the location of the RFID tag using a Received Signal Strength Indication (RSSI) algorithm based on the energy value of the tag signal at the point in time when the corresponding RFID reader receives the tag signal. As a condition of the location tracking of the RFID tag, it is assumed that synchronization is performed between the plurality of RFID readers.

As described above, when tracking the location of the RFID tag, the real-time location tracking apparatus 100 may use only first reception information that is received from RFID readers included in an RFID reader group, instead of using all the first reception information from the plurality of RFID readers receiving the tag signal. Therefore, it is possible to reduce an unnecessary calculation process and power consumption.

Also, as described above, the real-time location tracking apparatus 100 may further include the controller 140 and the second reception information receiver150.

The controller 140 may select a reference RFID reader from the RFID reader group, generated by the reader group generator 120, based on the first reception information and control the reference RFID reader to transmit a reference signal to constituent RFID readers that are remaining RFID readers excluding the reference RFID reader in the RFID reader group.

In order to accurately measure the location of the RFID tag, synchronization between RFID readers used for location measurement may need to be performed. According to an aspect of the present invention, the real-time location tracking apparatus 100 may perform synchronization between the RFID readers via the controller 140, without employing a separate apparatus.

The controller 140 may select a single reference RFID reader from the RFID reader group based on the first reception information.

According to an aspect of the present invention, the first reception information may include a first reception time value regarding a point in time when each of the RFID readers receives the tag signal. The controller 140 may select, as the reference RFID reader, an RFID reader with a minimum first reception time value. Specifically, when the first reception information includes the first reception time value, the reader group generator 120 may generate the RFID reader group according to a smaller order of the first reception time value. In this case, the controller 140 may select, as the reference RFID reader from RFID readers included in the selected RFID reader group, an RFID reader that has transmitted first reception information including the minimum first reception time value.

According to an aspect of the present invention, the first reception information may include a first energy value of the received tag signal. The controller 140 may select, as the RFID reader, an RFID reader with a maximum first energy value. Specifically, when the first reception information includes the first energy value, the reader group generator 120 may generate the RFID reader group according to a larger order of the first energy value. In this case, the controller 140 may select, as the reference RFID reader from RFID readers included in the selected RFID reader group, an RFID reader that has transmitted first reception information including the maximum first energy value.

The controller 140 may control the reference RFID reader to transmit a reference signal to constituent RFID readers that are remaining RFID readers excluding the reference RFID reader in the RFID reader group.

The reference signal denotes a signal that is transmitted from the reference RFID reader for synchronization between RFID readers. In order to prevent the constituent RFID readers from mistaking the reference signal for a tag signal transmitted from the RFID tag, the reference signal may include a code or identification (ID) different from the tag signal.

The second reception information receiver 150 may receive second reception information of the reference signal from the at least three RFID readers included in the RFID reader group.

In this case, according to an aspect of the present invention, the location calculator 130 may calculate the location of the RFID tag based on the first reception information and the second reception information that are received from the RFID readers included in the RFID reader group.

For synchronization between the RFID readers included in the RFID reader group, the location calculator 130 may calculate a difference between the first reception information of the tag signal and the second reception information of the reference signal and may calculate the location of the RFID tag according to the difference. Specifically, when tracking the location using the second reception information of the reference signal, synchronization between the RFID readers may be performed without using a separate apparatus.

According to an aspect of the present invention, second reception information associated with the reference RFID reader may include a delay time value that is spent when the reference RFID reader transmits the reference signal. Also, second reception information associated with a constituent RFID reader may include a second reception time value regarding a point in time when the constituent RFID reader receives the reference signal.

In this case, the location calculator 130 may calculate a time difference value between the first reception time value and the second reception time value with respect to the constituent RFID reader. Also, the location calculator 130 may calculate a time difference value between the first reception time value and the delay time value with respect to the reference RFID reader. Next, the location calculator 130 may track the location of the RFID tag using the time difference value. Since the time difference value is a time value where synchronization is performed based on the reference signal, synchronization may be performed between the RFID readers included in the RFID reader group.

According to an aspect of the present invention, the second reception information associated with the reference RFID reader may include a second energy value of the reference signal at a point in time when the reference RFID reader transmits the reference signal. Also, the second reception information associated with the constituent RFID reader may include a second energy value of the received reference signal.

In this case, the location calculator 130 may calculate an energy difference value between the first energy value and the second energy value of the received reference signal with respect to the constituent RFID reader. The location calculator 130 may calculate an energy difference value between the first energy value and the second energy value of the reference signal at the point in time when the reference RFID reader transmits the reference signal, with respect to the reference RFID reader. Next, the location calculator 130 may track the location of the RFID tag using the energy difference value. Since the energy difference value is a time value where synchronization is performed based on the reference signal, synchronization may be performed between the RFID readers included in the RFID reader group.

According to an aspect of the present invention, the time difference value or the energy difference value may be calculated in the RFID readers of the RFID reader group. In this case, the second reception information receiver 150 may receive the calculated time difference value or the energy difference value. The location calculator 130 may track the location of the RFID tag using the received time difference value or the energy difference value.

As described above, the RFID tag may periodically transmit the tag signal to the RFID reader. Therefore, according to an aspect of the present invention, even after the reference RFID reader is selected, the first reception information receiver 110 may receive the first reception information of the tag signal from the RFID readers included in the RFID reader group. In this case, the location calculator 130 may calculate the location of the RFID tag based on the first reception information of the tag signal and the second reception information of the reference signal that are received from the RFID readers included in the RFID reader group.

Specifically, when the first reception information of the tag signal is received from the RFID readers after the reference RFID reader is selected, it is possible to omit the selection process of the reference RFID reader and the receiving process of the second reception information of the reference signal and to synchronize the RFID readers using existing second reception information.

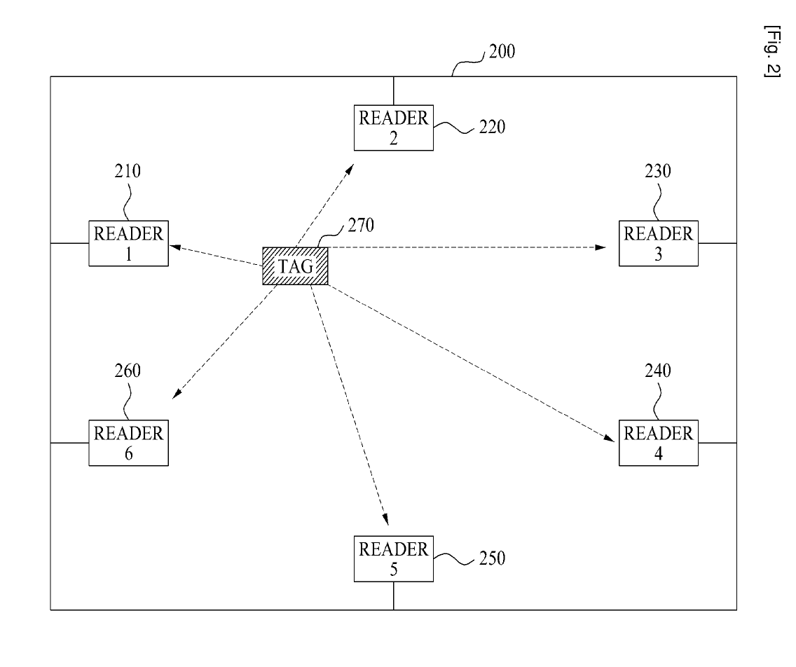

FIGS. 2 through 4 illustrate a location tracking operation using RFID according to an embodiment of the present invention.

A location tracking operation using a location tracking apparatus using RFID that includes the controller 140 and the second reception information receiver 150 of FIG. 1 will be described with reference to FIGS. 2 through 4. Hereinafter, a location processor corresponds to the real-time location tracking apparatus 100 of FIG. 1.

FIG. 2 illustrates an example 200 where an RFID tag 270 transmits a tag signal to a plurality of RFID readers (reader 1, reader 2, reader 3, reader 4, reader 5, and reader 6) 210, 220, 230, 240, 250, and 260 according to an embodiment of the present invention. As shown in FIG. 2, the RFID tag 270 may transmit the tag signal to the plurality of RFID readers (reader 1, reader 2, reader 3, reader 4, reader 5, and reader 6) 210, 220, 230, 240, 250, and 260. The plurality of RFID readers (reader 1, reader 2, reader 3, reader 4, reader 5, and reader 6) 210, 220, 230, 240, 250, and 260 may receive the tag signal, store a first reception time value regarding a point in time when the tag signal is received or a first energy value of the received tag signal, generate first reception information associated with the tag signal based on the value, and transmit the generated first reception information to the location processor (not shown).

The location processor receiving the first reception information may select at least three RFID readers as an RFID reader group and a single reference RFID reader based on the first reception information. Although not shown in FIG. 2, it is assumed that the RFID readers (reader 1, reader 2, and reader 6) 210, 220, and 260 are selected as the RFID reader group and the RFID reader (reader 1) 210 is selected as the reference RFID reader.

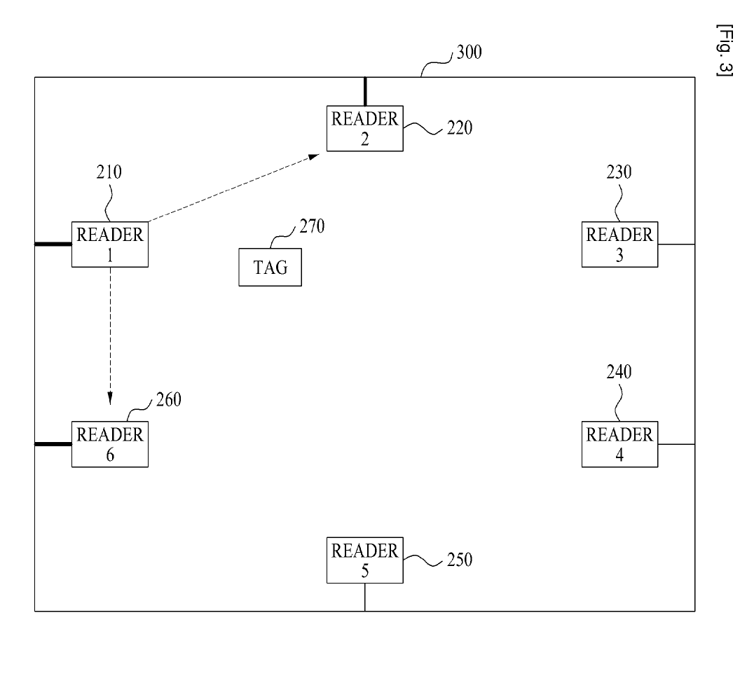

FIG. 3 illustrates an example 300 where a reference RFID reader transmits a reference signal to constituent RFID readers according to an embodiment of the present invention. As described above, the RFID reader (reader 1) 210 is selected as the reference RFID reader, and the RFID readers (reader 2) 220 and the RFID reader (reader 6) 260 are selected as the constituent RFID readers. Therefore, the RFID reader (reader 1) 210 may transmit the reference signal to the RFID readers (reader 2 and reader 6) 220 and 260.

The RFID readers (reader 2 and reader 6) 220 and 260 receiving the reference signal may store a second time reception time regarding a point in time when the reference signal is received, or a second energy value of the received reference signal.

For example, the RFID readers (reader 2 and reader 6) 220 and 260 may transmit the stored second reception time value or the second energy value of the received reference signal to a location processor (not shown). The RFID reader (reader 1) 210 may transmit, to the location processor, a delay time value that is spent for transmitting the reference signal, or an energy value of the reference signal when transmitting the reference signal.

Also, for example, the RFID readers (reader 2 and reader 6) 220 and 260 may calculate a time difference value between the stored second reception time value and the stored first reception time value, or an energy difference value between the second energy value of the received reference signal and the first energy value, and then transmit the time difference value or the energy difference value to the location processor. The RFID reader (reader 1) 210 may calculate a time difference value between the delay time value and the first reception time value, or an energy difference value between the energy value of the reference signal when transmitting the reference signal and the first energy value, and then transmit the time difference value or the energy difference value to the location processor.

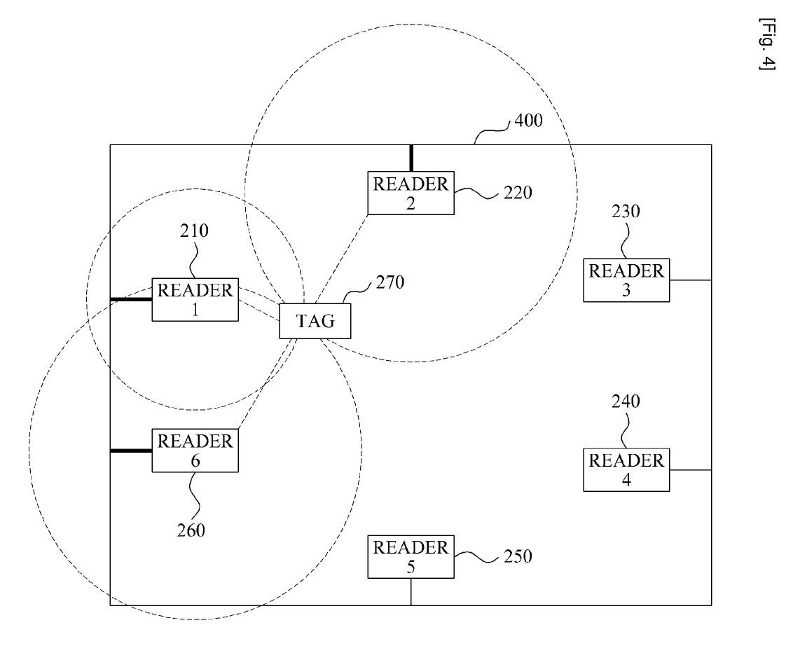

FIG. 4 illustrates an example 400 of calculating a location of an RFID tag 270 according to an embodiment of the present invention. A location processor (not shown) may generate circles that use RFID readers (reader 1, reader 2, and reader 6) 210, 220, and 260 as the origin, respectively, using a first reception time value, a time delay value, and a second reception time value, or using a first energy value, an energy value of a reference signal when transmitting the reference signal, and a second energy value that are received from the RFID readers (reader 1, reader 2, and reader 6) 210, 220, and 260. The location processor may calculate crossing points of the circles as the location of the RFID tag.

Although not shown in FIGS. 3 and 4, a reference RFID reader according to an aspect of the present invention may simply transmit the reference signal to constituent RFID readers. Only the constituent RFID readers may transmit a second reception time value of the reference signal or a second energy value of the reference signal to the location processor. In this case, the location processor may calculate the location of the RFID tag using the received second reception time value or the second energy value of the reference signal.

Specifically, when it is assumed that the RFID reader (reader 1) 210 is selected as the reference RFID reader, and the RFID readers (reader 2, reader 5, and reader 6) 220, 250, and 260 are selected as constituent RFID readers, the location processor may receive the second reception time value of the reference signal or the second energy value of the received reference signal from the RFID readers (reader 2, reader 5, and reader 6) 220, 250, and 260 and generate circles that use the RFID readers (reader 2, reader 5, and reader 6) 220, 250, and 260 as the origin, respectively, and calculate the crossing point of the circles as the location of the RFID tag.

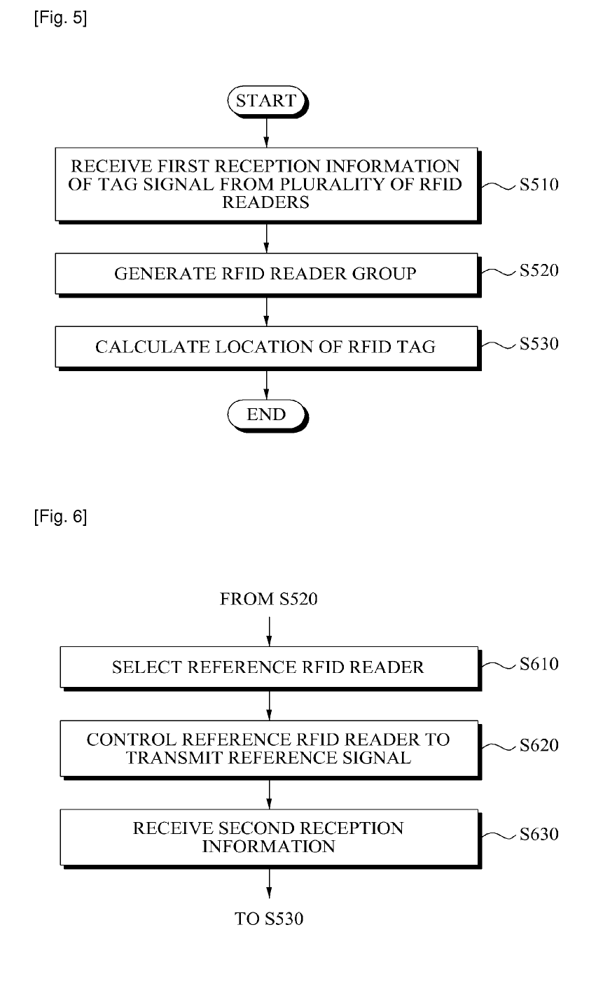

FIGS. 5 and 6 are flowchart illustrating a method for real-time location tracking using RFID according to an embodiment of the present invention. Hereinafter, the method for real-time location tracking will be described in detail with reference to FIGS. 5 and 6.

In operation 5510, the real-time location tracking method may receive, from a plurality of RFID readers, first reception information of a tag signal that is received from an RFID tag.

The RFID tag may transmit the tag signal to the plurality of RFID readers for location tracking of an object with the attached RFID tag. The RFID tag may periodically transmit the tag signal to the RFID readers.

The plurality of RFID readers may generate first reception information with respect to the received tag signal. In operation S510, the generated first reception information may be received.

In operation S520, the real-time location tracking method may select, from the plurality of RFID readers, at least three RFID readers based on the first reception information to generate an RFID reader group including the selected at least three RFID readers. The RFID reader group denotes a set of RFID readers that are used to track a location of the RFID tag.

According to an aspect of the present invention, it is possible to track the location of the RFID tag using a triangulation scheme. Therefore, in operation S520, the real-time location tracking method may select at least three RFID readers from a plurality of RFID readers transmitting the first reception information and generate the RFID reader group including the selected at least three RFID readers.

According to an aspect of the present invention, in operation S520, the real-time location tracking method may generate the RFID reader group according to a larger order of the first reception time value regarding a point in time when the tag signal included in the first reception information is received.

The first reception time value denotes a time value at a point in time when a corresponding RFID reader receives the tag signal. As the first reception time value becomes smaller, the RFID reader may be positioned in a closer location from the RFID tag that transmitted the tag signal. As the location from the RFID tag becomes closer, the location may be more accurately measured. Therefore, in operation S520, the real-time location tracking method may group the at least three RFID readers into the RFID reader group according to the smaller order of the first reception time value.

In operation S530, the real-time location tracking method may calculate a location of the RFID tag based on first reception information that is received from the at least three RFID readers included in the RFID reader group.

As described above, the first reception information may include the first reception time value regarding the point in time when each of at least three RFID readers of the RFID reader group receive the tag signal from the RFID tag. According to an aspect of the present invention, it is possible to calculate the location of the tag using a TOA algorithm based on the time value when a corresponding RFID reader receives the tag signal. In this case, as a condition of the location tracking of the RFID tag, it is assumed that synchronization is performed between the plurality of RFID readers.

As described above, when tracking the location of the RFID tag, the real-time location tracking method may use only the first reception information that is received from RFID readers included in an RFID reader group, instead of using all the first reception information from the plurality of RFID readers receiving the tag signal. Therefore, it is possible to reduce an unnecessary calculation process and power consumption.

According to an embodiment of the present invention, the real-time location tracking method may further include operation S610 of selecting a reference RFID reader from the at least three RFID readers included in the RFID reader group based on the first reception information, operation S620 of controlling the reference RFID reader to transmit a reference signal to constituent RFID readers that are remaining RFID readers excluding the reference RFID reader in the RFID reader group, and operation S630 of receiving second reception information of the reference signal from the at least three RFID readers included in the RFID reader group.

In operation S610, the real-time location tracking method may select the single reference RFID reader from the at least three RFID readers included in the RFID reader group, which are selected in operation S520, based on the first reception information that is received in operation S510.

According to an aspect of the present invention, in operation S610, the real-time location tracking method may include a first reception time value regarding a point in time when the tag signal included in the first reception information is received and select, as the reference RFID reader, an RFID reader with a maximum first reception time value.

In operation S620, the real-time location tracking method may control the reference

RFID reader to transmit the reference signal to constituent RFID readers that are remaining RFID readers excluding the RFID reader in the RFID reader group.

The reference signal denotes a signal that is transmitted from the reference RFID reader for synchronization between RFID readers. In order to prevent the constituent RFID readers from mistaking the reference signal for a tag signal transmitted from the RFID tag, the reference signal may include a code or ID different from the tag signal.

In operation S630, the real-time location tracking method may receive second reception information of the reference signal from the at least three RFID readers included in the RFID reader group.

In this case, in operation S530, the real-time location tracking method may calculate the location of the RFID tag based on the first reception information and the second reception information that are received from the RFID readers included in the RFID reader group.

According to an aspect of the present invention, for synchronization between the

RFID readers included in the RFID reader group, the real-time location tracking method may calculate a difference between the first reception information of the tag signal and the second reception information of the reference signal and may calculate the location of the RFID tag according to the difference in operation S530. Specifically, when tracking the location using the second reception information of the reference signal, synchronization between the RFID readers may be performed without using a separate apparatus.

According to an aspect of the present invention, second reception information associated with the reference RFID reader may include a delay time value that is spent when the reference RFID reader transmits the reference signal. Also, second reception information associated with a constituent RFID reader may include a second reception time value regarding a point in time when the constituent RFID reader receives the reference signal.

In this case, the real-time location tracking method may calculate a time difference value between the first reception time value and the second reception time value with respect to the constituent RFID reader in operation S530. Also, in operation S530, the real-time location tracking method may calculate a time difference value between the first reception time value and the delay time value with respect to the reference RFID reader. In operation S530, the real-time location tracking method may track the location of the RFID tag using the time difference value. Since the time difference value is a time value where synchronization is performed based on the reference signal, synchronization may be performed between the RFID readers included in the RFID reader group.

Embodiments of the real-time location tracking method using RFID have been described above and a configuration of the aforementioned real-time location tracking using RFID of FIG. 1 may be applicable to the embodiments. Therefore, further detailed descriptions will be omitted here.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of example embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for real-time location tracking using Radio Frequency Identification (RFID), the apparatus comprising:
a first reception information receiver to receive first reception information of a tag signal from a plurality of RFID readers that receives the tag signal from an RFID tag;
a reader group generator to select, from the plurality of RFID readers, at least three RFID readers based on the first reception information and generate an RFID reader group including the selected at least three RFID readers; and
a location calculator to calculate a location of the RFID tag based on first reception information that is received from the at least three RFID readers included in the RFID reader group.

2. The apparatus of claim 1, wherein:
the first reception information includes a first reception time value regarding a point in time when each of the RFID readers receives the tag signal, and
the reader group generator generates the RFID reader group according to a smaller order of the first reception time value.

3. The apparatus of claim 1, wherein:
the first reception information includes a first energy value of the received tag signal, and
the reader group generator generates the RFID reader group according to a larger order of the first energy value.

4. The apparatus of claim 1, further comprising:
a controller to select a reference RFID reader from the at least three RFID readers included in the RFID reader group based on the first reception information and control the reference RFID reader to transmit a reference signal to constituent RFID readers that are remaining RFID readers excluding the reference RFID reader in the RFID reader group; and
a second reception information receiver to receive second reception information of the reference signal from the at least three RFID readers included in the RFID reader group.

5. The apparatus of claim 4, wherein the location calculator calculates the location of the RFID tag based on the first reception information and the second reception information that are received from the at least three RFID readers included in the RFID reader group.

6. The apparatus of claim 4, wherein:
the first reception information includes a first reception time value regarding a point in time when each of the RFID readers receives the tag signal, and the controller selects, as the reference RFID reader, an RFID reader with a minimum first reception time value.

7. The apparatus of claim 4, wherein:
the first reception information includes a first energy value of the received tag signal, and
the controller selects, as the reference RFID reader, an RFID reader with a maximum first energy value.

8. The apparatus of claim 4, wherein:
second reception information associated with the reference RFID reader includes a delay time value that is spent when the reference RFID reader transmits the reference signal, and
second reception information associated with a constituent RFID reader includes a second reception time value regarding a point in time when the constituent RFID reader receives the reference signal.

9. The apparatus of claim 4, wherein:
second reception information associated with the reference RFID reader includes a second energy value of the reference signal at a point in time when the reference RFID reader transmits the reference signal, and
second reception information associated with a constituent RFID reader includes a second energy value of the received reference signal.

10. A method for real-time location tracking using RFID, the method comprising:
receiving, from a plurality of RFID readers, first reception information of a tag signal that is received from an RFID tag;
selecting, from the plurality of RFID readers, at least three RFID readers based on the first reception information to generate an RFID reader group including the selected at least three RFID readers; and
calculating a location of the RFID tag based on first reception information that is received from the at least three RFID readers included in the RFID reader group.

11. The method of claim 10, wherein the selecting and the generating generates the RFID reader group according to a larger order of a first reception time value with respect to a point in time when the tag signal included in the first reception information is received.

12. The method of claim 10, further comprising:
selecting a reference RFID reader from the at least three RFID readers included in the RFID reader group based on the first reception information;
controlling the reference RFID reader to transmit a reference signal to constituent RFID readers that are remaining RFID readers excluding the reference RFID reader in the RFID reader group; and
receiving second reception information of the reference signal from the at least three RFID readers included in the RFID reader group,
wherein the calculating of the location calculates the location of the RFID tag based on the first reception information and the second reception information that are received from the reference RFID reader and the constituent RFID readers.

13. The method of claim 10, wherein the selecting of the reference RFID reader selects, as the reference RFID reader, an RFID reader with a maximum first reception time value with respect to a point in time when the tag signal included in the first reception time is received.

14. The method of claim 12, wherein:
second reception information associated with the reference RFID reader includes a delay time value that is spent when the reference RFID reader transmits the reference signal, and
second reception information associated with a constituent RFID reader includes a second reception time value regarding a time when the constituent RFID reader receives the reference signal.
